(19) United States
(12) Patent Application Publication
(10) Pub. No.: US 2013/0167333 A1
(43) Pub. Date: Jul. 4, 2013

(54) FASTENING DEVICE FOR WASTE BAGS

(71) Applicants: Kent Andersson, Orebro (SE); Peter Kvamás, Kumla (SE)

(72) Inventors: Kent Andersson, Orebro (SE); Peter Kvamás, Kumla (SE)

(21) Appl. No.: 13/806,151

(22) PCT Filed: Jun. 22, 2011
(86) PCT No.: PCT/SE2011/000118

§ 371 Date: Mar. 14, 2013

(30) Foreign Application Priority Data
Jun. 24, 2010 (SE) 1000674-0

(51) Int. Cl. F16B 2/22

(52) U.S. Cl. CPC F16B 2/22
USPC 24/545

(57) ABSTRACT

The invention relates to a fastening device that prevents waste bags from sliding into the waste bins/trash. The above mentioned fixture serves as the locking of the bags through punching that provides joint function for up and down angle. Fixture design consists of an upper fastening member and a lower tillable fastening member, made of a flexible, thin, flat material, cut out or punched with slots on opposite sides for slant of the lower portion of the fastener. Slits between the upper and lower fastening member has multiple functions, both for spin 180 degrees to the lower fastening member for bag obsession, and for attaching the device closer to the curved surfaces. By the design of said device allows flexibility and slant and attachment to curved surfaces. Trough special punching and embossing in combination with a flexible, thin and flat material, reducing tension. Cited device is generally adapted for curved area shapes, but can also be attached to flat surfaces.

Device that prevents the waste bags from sliding down into the waste receptacle is made possible by cited fastening device, designed with two attachment parts, an upper fastening member (1) intended to be attached to new or existing waste bags in or outside surfaces and a lower fastening member (2) intended for attaching the bags.

The above fixture can be used separately or more in number for locking bags, through flexible angle opportunities, joint function and punching up and down angle. The design of the fastener can be varied in size depending on the vessel volume and is particularly suited for curved surfaces such as cylindrical, tapered and spherical.

Available documents GB 2294193, EP 1396444, U.S. Pat. No. 6,286,706, DE 10343474 of innovations that describe art, but which differs from our attachment. Common to these documents is the absence of solutions in the patent claims for curved surfaces such as cylindrical, tapered and spherical as well as up and down angle of attachment and optional placement in height, on the inside or outside. Common to all three of the documents GB 2294193, EP 1396444, U.S. Pat. No. 6,286,706 are that the fastening device are pre bent, which there by mutually exhibit more similarities to each other than against the cited application.

Common to two of the documents GB 2294193 and EP 1396444 seems to be that they are dependent on a supportive upper edge of the container/basket.

DE 10343474 fastening member for application against the waste containers and surfaces, taking not charge tension over curved surfaces, for example through slits or punch, according to our opinion, the fastener is not designed so that the bag can be released without the risk of defects, according to the said three point systems.

GB 2294193 fastener variation in size is not mentioned in the patent claims, the fastener does not have function up or down angle, is of a fixed structure such as molded and dependent on a support edge.

U.S. Pat. No. 6,286,706 has not optional/variable location that is tailored for new or existing waste bags in the market, together with various vascular volumes, fixture variation in size is not mentioned in the patent claims. The device is of a type “permanent tie-down device” with “tension clamp” as optional accessory, the device is of a fixed structure such as molded parts. In our opinion can not the resolution handle existing bags that are available in the market without the risk of defects in the bag.

EP1396444 fixture variation in size is not mentioned in the patent claims, the device is of a partially fixed structure such as molded with the function of “clamping clip” and is based rather on collaborative member of a system. In addition to these records are others such as U.S. Pat. No. 5,261,553, U.S. 2006163257, U.S. Pat. No. 4,923,087, U.S. 2009050628 which also does not show any similar solutions in relation to cited application.

This cited device for waste containers, covered by one or more fasteners, consisting of an upper fastening member (1) for attachment to the waste receptacle and a lower fold-fastening member (2) for fixation of the waste bag. The keyhole-like recesses/slots (11.12) FIG. 4-5 represents “Border” between the upper and lower fastening member. Fastening device is made of a flexible, thin and flat material. Cut out or punched with slots on opposite sides, for slant of the lower portion of the fastener (11.12) FIG. 4-5.

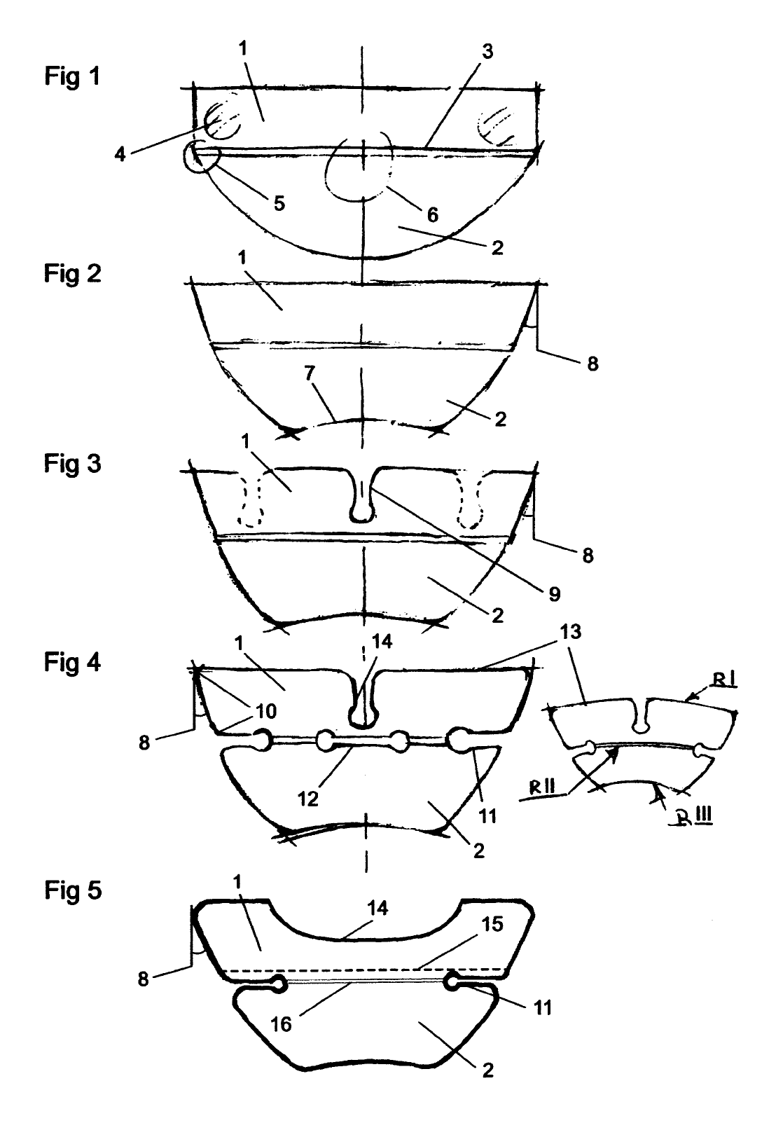

The above-mentioned slits between the upper fastening member (1) FIG. 4-5 for application against various vascular in and outside surfaces and lower fastening member (2) FIG. 4-5 for the attachment of bag, has multiple functions, and the bag fixation, both made possible angle of the lower fastening member (2) FIG. 4-5 for the bag vertically, over curved surfaces and the strength of the material increases. Fastening members up and down angle ensures easy handling during on and removing the bag. Fastening device is designed so that the bag can be fixed and released, without risk of defects on the bag. Cut outs of the fixing upper fastening member (14) FIGS. 4-5 eliminates tension in the material, when the device is applied to curved surfaces. Fixture outer ends of the upper fastening member (8) FIG. 2-5 is incleaned to avoid the drop against the conical surfaces. Fastening device upper fastening member(1) and lower fastening member (2) with different notches and punches (9, 11, 12.14), FIG. 3-5 eliminates the tension of the material in bending and application, which allows for extra adhesion on cylindrical, conical or spherical surfaces. Lower limit for adhesive fastening member (15) FIG. 5 if this application method is preferred, dashed line. Trail (16) FIG. 5, a double solid line, in the form of embossed underneath the fastening device upper fastening member (16), FIG. 5 to expose the joint function of curved surfaces which maintain the shaft straight, symmetrically placed over the curved slots (11,12) FIG. 4-5, for maximum strength and tiltable, slant occurs vertically. Small FIG. 4 alternative solution, maximum designed for cone-shaped containers.

The device is optional/variable investment option, vertically or horizontally from waste bag/vessel size, execution and handles the design, internally or externally. Existing adhesive bandage which application method of waste containers with mesh structure, secured by means of separate connections to the container facing in or outside, which then serve to stop rotation, thereby securing the fastener fixing the vessel on both sides.

The fastening device is designed so that a single action can be applied to most existing vessels, without using either the tools or professional help. Fastening device can be integrated directly into the waste receptacle and function as separate parts, which in turn is applied to the existing waste bins in and outside surfaces.

Through the new design of the said attachment, be allowed flexibility and angulation, and attachment to curved surfaces. Through special punching and stamping in FIG. 4-5, combined with a flexible, thin and flat material, reduces the tension optimally. Cited device is generally adapted for curved area shapes such as cylindrical or conical receptacles in or outside surfaces, but can also be attached to flat surfaces.

1. Fastening device for fixation of waste bags to prevent waste bags from sliding down into a waste receptacle designed with two attachment parts characterized by that the fastener consists of an upper fastening member (1) for the attachment against the vessel and a lower tiltable fastening member (2) intended for fixation of waste bag, that the fastener is made of a flexible, thin and flat material, and that it is cut out or punched with slots (10,11) on opposite sides for slant of the lower portion of the fastener (2) with slits between the upper and the lower fastening member permits tilting of the lower fastening member at 180 degrees for fixing the waste bag and allows the attachment of the upper fastening member (1) for curved surfaces, that the fastening device lower fastening member (2) has round shape, the fastening device outer ends (8) in the upper attachment part (1) is in incleaned for adaptation to the conical surfaces, that the fastener includes (9,12,14) in the upper mounting portion, and in the middle of the device between the upper and the lower bottom mounting part, that the fastener all the aforesaid recess/punches (9,10,11,12,14) admits reduced tension in the material in bending and application to curved surfaces, to a joint (16) in the form of an imprint is positioned below a lower limit (15) for the upper attachment part (1), which uncovers the joint function of the arched surfaces and allows tiltable vertically.

2. Fastening device for fixation of waste bags according to claim 1 characterized that the device is placed vertically or horizontally.

3. Fastening device for fixation of waste bags according to claim 1 characterized of the device is applied to the waste receptable with the network structure and secured with separate dressing in bowl.

4. Fastening device for fixation of waste bags according to claim 1 characterized of the recess can be varied in size and shape.

5. Fastening device for fixation of waste bags according to claim 1 characterized of the imprint joint (16) can be bent.
